(19) United States
(12) Patent Application Publication
(10) Pub. No.: US 2022/0407074 A1
(43) Pub. Date: Dec. 22, 2022

(54) ELECTRODE, METHOD OF MANUFACTURING THE SAME, AND ELECTROCHEMICAL DEVICE

(71) Applicants: Masahiro MASUZAWA, Kanagawa (JP); Kohji Matsuoka, Kanagawa (JP); Yuu Zama, Kanagawa (JP); Tomoya Ohmura, Kanagawa (JP); Ryuji Higashi, Kanagawa (JP); Hideo Yanagita, Tokyo (JP)

(72) Inventors: Masahiro MASUZAWA, Kanagawa (JP); Kohji Matsuoka, Kanagawa (JP); Yuu Zama, Kanagawa (JP); Tomoya Ohmura, Kanagawa (JP); Ryuji Higashi, Kanagawa (JP); Hideo Yanagita, Tokyo (JP)

(73) Assignee: Ricoh Company, Ltd., Tokyo (JP)

(21) Appl. No.: 17/756,072

(22) PCT Filed: Nov. 18, 2020
(86) PCT No.: PCT/JP2020/043022

§ 371 Date: May 16, 2022

(30) Foreign Application Priority Data
Nov. 20, 2019 (JP) 2019-209912

(51) Int. Cl. H01M 4/62; H01M 4/04

(52) U.S. Cl. CPC H01M 4/62; H01M 4/0404; H01M 4/0409; H01M 2004/021

(57) ABSTRACT

An electrode is capable of achieving both the safety of a corresponding electrochemical device and at least one of the output or the capacity retention rate. The electrode contains an electrode composite material layer, an insulating layer, and an electrode substrate. The electrode composite material layer and the insulating layer are sequentially formed on the electrode substrate, and the electrode composite material layer is coated by the insulating layer. An average value of the coverage percentage of the electrode composite material layer by the insulating layer in the electrode is 90% or more.

### TECHNICAL FIELD

The present invention relates to an electrode, a method of manufacturing electrode, and an electrochemical device.

### BACKGROUND ART

Electrodes used for storage devices such as lithium ion secondary batteries, power generation devices such as fuel cells, and electrochemical devices such as photovoltaic generation devices are formed with electrode composite material layers on electrode substrates.

Amid the growing demand for higher output, higher capacity and longer life of electrochemical devices, various problems have arisen due to the quality of the electrodes. For example, when a defect occurs at the surface, end, or interface of an electrode, certain materials may be deposited at the defect site or the machine may be in contact with the interface of the electrode due to aging or vibration. As a result, short circuits, leaks or the like are generated, resulting in ignition of the electrochemical device.

A separator is provided between the positive-electrode and the negative-electrode in a storage device such as a lithium ion secondary battery. As separators, porous films made of resin, such as polyethylene, polypropylene and the like are mainly used.

However, these separators have low heat resistance. Specifically, when an internal short circuit occurs between the positive-electrode and the negative-electrode, or when a sharp-shaped protrusion such as a nail pierces the lithium-ion secondary battery, the reaction heat generated instantaneously melts the separator and expands the short circuit. As a result, reaction heat is further generated and abnormal heating is generated.

When an internal short circuit occurs between the positive-electrode and the negative-electrode, Joule heat is generated due to contact resistance of the contact portion on the negative-electrode side of the short circuit portion. The generated Joule heat raises the temperature of the positive-electrode, generates abnormal reaction heat, and promotes abnormal heating.

Patent Literature 1 discloses a forming of a porous insulating layer including an inorganic filler and a resin binder on a surface of active material layer. Here, the porous insulating layer has a first region on which said porous insulating layer is formed, and a second region on which said porous insulting layer is not formed.

### SUMMARY OF INVENTION

### Technical Problem

However, there is a problem in that abnormal heating occurs when the ratio of the forming region decreases. In addition, there is a problem in that at least one of the output or capacity retention rate of the electrochemical device decreases as the ratio of the formed region increases.

An object of the present invention is to provide an electrode capable of achieving both the safety of the electrochemical device and at least one of the output or capacity retention rate.

### Solution to Problem

In one aspect of the present invention, an electrode substrate is sequentially formed with an electrode composite material layer and an insulating layer, and the electrode composite material layer is coated with the insulating layer, wherein an average value of the coverage percentage of the electrode composite material layer by the insulating layer is 90% or more.

### Effects of Invention

According to the present invention, an electrode capable of ensuring both the safety of the electrochemical device and at least one of the output or capacity retention rate can be provided.

### BRIEF DESCRIPTION OF DRAWINGS

FIG. 1A is a diagram illustrating an example of an electrode of the present embodiment.

FIG. 1B is a diagram illustrating an example of an electrode of the present embodiment.

FIG. 2A is a schematic view illustrating an example of forming an insulating layer using a liquid discharge device.

FIG. 2B is a schematic view illustrating an example of forming an insulating layer using a liquid discharge device.

FIG. 3A is a schematic view illustrating another example of forming an insulating layer using a liquid discharge device.

FIG. 3B is a schematic view illustrating another example of forming an insulating layer using a liquid discharge device.

FIG. 4 is an example of an optical microscopic image of the side of the electrode on which the insulating layer is formed.

FIG. 5 is the image obtained by Fourier transforming the optical microscope image of FIG. 4.

FIG. 6 is a schematic view illustrating an example of a method of manufacturing the negative-electrode according to the present embodiment.

FIG. 7 is a schematic view illustrating another example of a method of manufacturing the negative-electrode according to the present embodiment.

FIG. 8 is a schematic view illustrating a modification of the liquid discharge device of FIGS. 6 and 7.

FIG. 9 is a cross-sectional view illustrating an example of an electrochemical device according to the present embodiment.

### DESCRIPTION OF EMBODIMENTS

Hereinafter, embodiments for carrying out the present invention will be described with reference to the drawings. In some cases, the description of the same component parts may be omitted with the same reference numerals.

<Electrode>

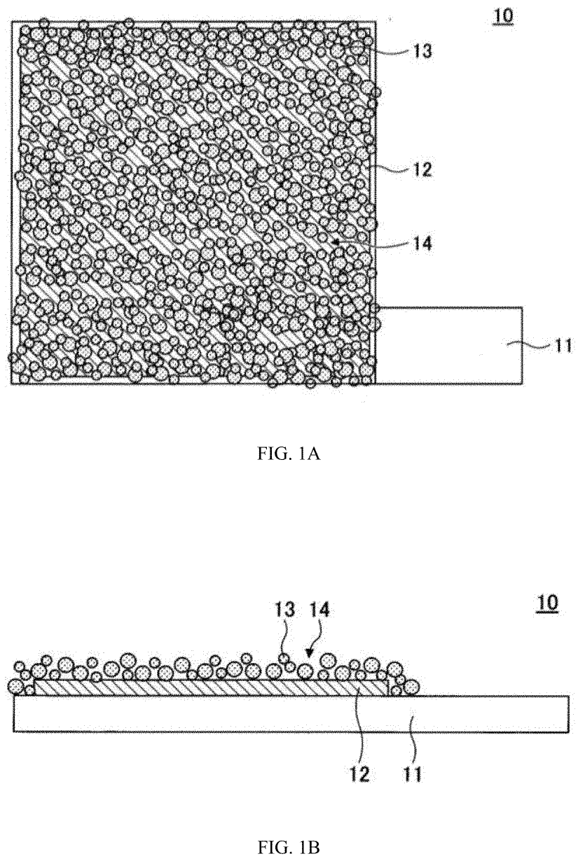

FIGS. 1A and 1B illustrate an example of an electrode according to this embodiment. FIGS. 1A and 1B are planar and cross-sectional views, respectively.

An electrode 10 is sequentially formed on an electrode substrate 11 with an electrode composite material layer 12 and an insulating layer 13. Here, the electrode composite material layer 12 is coated with the insulating layer 13. The insulating layer 13 has an average distribution of micro gaps 14.

In the electrode 10, the electrode composite material layer 12 and the insulating layer 13 are sequentially formed on one surface of the electrode substrate 11. However, the electrode composite material layer 12 and the insulating layer 13 may be sequentially formed on both surfaces of the electrode substrate 11.

In the specification and claims, the sequential formation of the electrode composite material layer 12 and the insulating layer 13 on the electrode substrate 11 refers to the insulating layer 13 that is formed on the electrode composite material layer 12 opposite to the electrode substrate 11, for example. Other layers may be further formed between the electrode composite material layer 12 and the insulating layer 13.

The average value of the coverage percentage of the electrode composite material layer 12 by the insulating layer 13 of the electrode 10 is 90% or more and is preferably 95% or more. When the average value of the coverage percentage of the electrode composite material layer 12 by the insulating layer 13 of the electrode 10 is less than 90%, the safety of the electrochemical device is reduced.

The average value of the coverage percentage of the electrode composite material layer 12 by the insulating layer 13 can be obtained as follows. First, a microscopic image (approximately 5 to 50 times) of any area (approximately 5 points) of the surface on which the insulating layer 13 of the electrode 10 is formed is stored as image data such as a bitmap file, a JPEG file or the like. Next, the image data is binarized by image editing and processing software such as Photoshop (Registered trademark) based on the shading of colors, and the ratio of the density of 50% or more, that is, the coverage ratio of the electrode composite material layer 12 by the insulating layer 13 is determined in any of the regions. Then, the average value is calculated.

Here, the insulating layer 13 can be formed by discharging droplets of the liquid composition for the insulating layer, which will be described later, onto the electrode composite material layer 12 at predetermined intervals using a liquid discharge device.

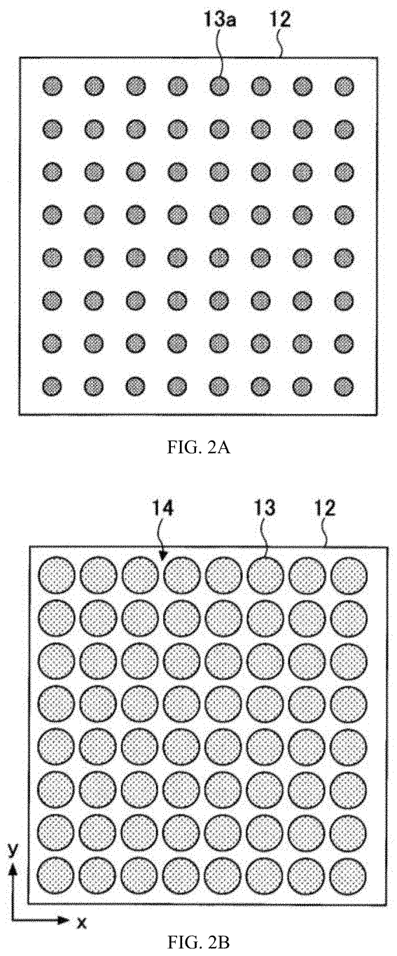

FIGS. 2A and 2B illustrate an example in which an insulating layer is formed using a liquid discharge device.

For example, the droplets 13a of the 8×8 liquid composition for insulating layer immediately after the electrode composite material layer 12 dropped are small in diameter (see FIG. 2A), but after several hundred milliseconds to several seconds, the droplets 13a of the liquid composition for insulating layer 13 expand. Drying the droplets 13a of the liquid composition for insulating layer forms the insulating layer 13 (see FIG. 2B). At this time, if the gaps between the droplets 13a of the liquid composition for insulating layer is sufficiently increased and the amount of the droplets 13a of the liquid composition for insulating layer is sufficiently reduced, the insulating layer 13 can be formed in which the micro gaps 14 are averagely distributed without covering the entire surface of the electrode composite material layer 12.

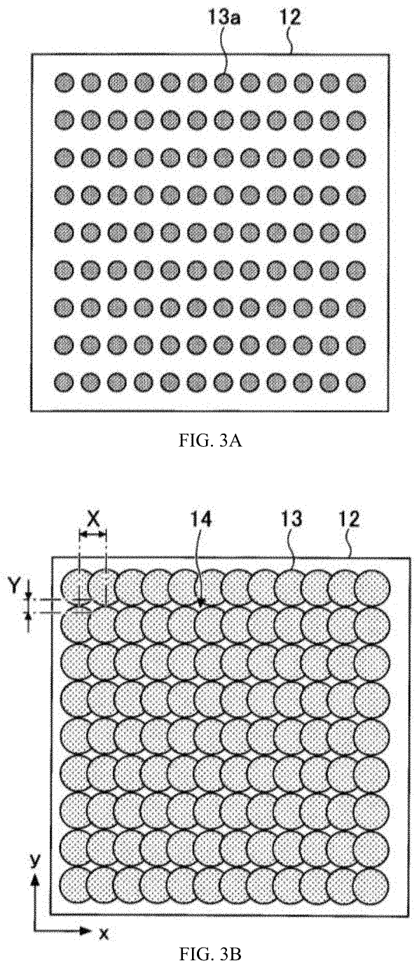

FIGS. 3A and 3B illustrate another example of using a liquid discharge device to form an insulating layer.

Another example is the same as FIGS. 2A and 2B except that the number of droplets 13a of the liquid composition for insulating layer is changed to 9×12 (see FIG. 3A). The smaller spacing of the droplets 13a of the adjacent liquid composition for the insulating layer reduces the percentage of the micro gaps 14 in the insulating layer 13 (see FIG. 3B). Thus, the ratio of the micro gaps 14 can be adjusted by adjusting the spacing of droplets 13a of the liquid composition for insulating layer.

In fact, when the insulating layer 13 is formed, as illustrated in FIGS. 2A to 3B, the gaps of the same size are not formed. The size of the droplets 13a of the liquid composition for insulating layer actually discharged varies slightly from nozzle to nozzle, and the direction in which the droplets 13a of the liquid composition for insulating layer are discharged also varies slightly. Thus, micro gaps 14, i.e., randomly sized micro gaps 14, are formed that are not of the same size. However, as illustrated in FIGS. 2A to 3B, the size of the micro gaps 14 can be adjusted by adjusting the spacing of the droplets 13a of the adjacent liquid composition for insulating layer, so that the average value of the coverage of the electrode composite material layer 12 by the insulating layer 13 can be adjusted at the discharge resolution of the liquid discharge device.

In FIGS. 2A and 2B, the insulating layer 13 includes a plurality of dots arranged in a linear fashion, with adjacent dots separated by predetermined spacing.

In FIGS. 3A and 3B, the insulating layer 13 includes a plurality of dots arranged in a linear, with micro gaps 14 of length X and width Y (<X) distributed on average. Here, the linear dots have portions overlapping or abutting with adjacent dots. In addition, by forming the insulating layer 13 using the liquid discharge device, the width Y of the micro gaps 14 can be 100 μm or less. As described above, since the micro gaps 14 are averagely distributed in the insulating layer 13, the velocity distribution of ions transmitted through the electrode composite material layer 12 can be uniform. Therefore, even if the average value of the coverage percentage of the electrode composite material layer 12 by the insulating layer 13 is 90% or more, at least one of the output or capacity retention rate of the electrochemical device is unlikely to be reduced.

In contrast to this, since the conventional insulating layer has a gap size of about 500 μm, the velocity distribution of ions transmitted through the electrode composite material layer becomes non-uniform. Therefore, when the coating ratio of the electrode composite material layer by the insulating layer is increased, at least one of the output or capacity retention rate of the electrochemical device decreases.

In the insulating layer 13, the micro gaps 14 are periodically formed in the width direction, i.e., the x direction, of the micro gap 14. This is due to the periodic arrangement of the discharge holes of the liquid discharge head. Since the micro gaps 14 are periodically formed with respect to the width direction of the micro gaps 14, they are evenly distributed, and thus distribution of ions that pass through the electrode composite material layer 12 can be uniformly maintained.

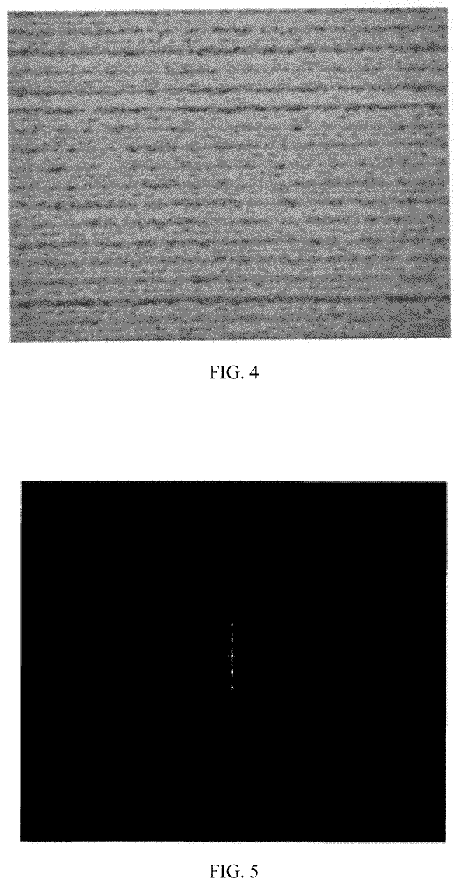

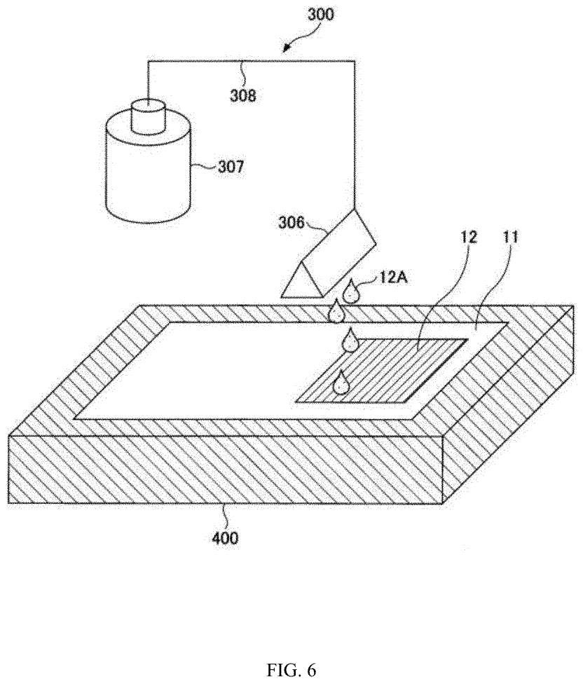

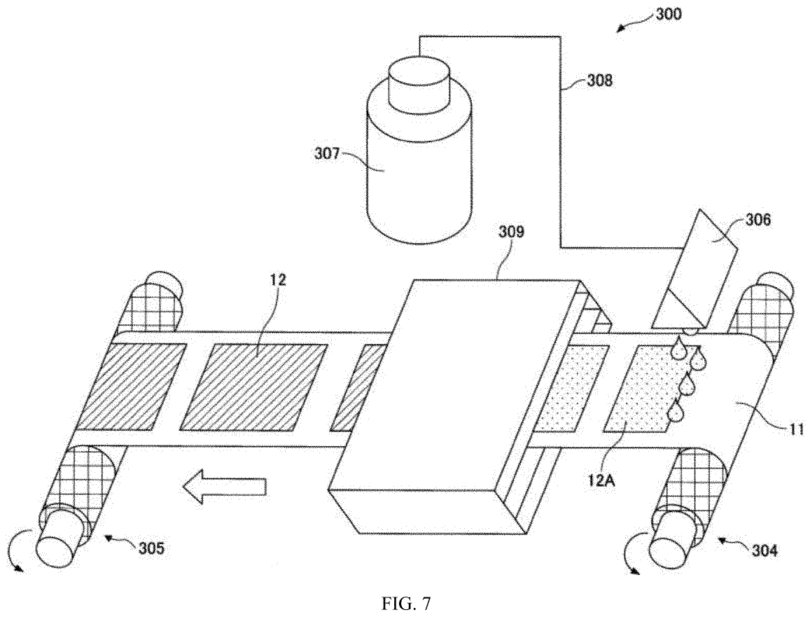

It can be confirmed that the micro gaps 14 are periodically formed with respect to the width direction of the micro gaps 14, because the image in which a Fourier transform (see FIG. 5) of the microscopic image (see FIG. 4) of the surface on which the insulating layer 13 of the electrode 10 is formed has periodicity. In FIG. 4, the horizontal direction (the length direction of the micro gaps 14) is the moving direction of the liquid discharge head, and the line formed of dots arranged in a linear in a horizontal direction is formed with a spacing corresponding to the spacing of the discharge holes because the discharge holes of the liquid discharge head are arranged with a constant spacing. Reflecting the periodicity of the longitudinal direction (the width direction of the micro gaps 14) in FIG. 4, high brightness portions are arranged longitudinally with constant spacing in FIG. 5. Thus, it can be seen that the micro gaps 14 are periodically formed in the direction of the width of the micro gaps 14.

<Electrode Substrate>

As the material constituting the electrode substrate 11, there is no particular limitation in the case of an electrically conductive material, and the electrode substrate 11 can be appropriately selected according to the purpose.

Examples of the material constituting the positive-electrode substrate include stainless steel, nickel, aluminum, copper, titanium, tantalum, and the like. Of these, stainless steel and aluminum are particularly preferred.

Examples of materials constituting the negative-electrode substrate include stainless steel, nickel, aluminum, copper, and the like. Of these, stainless steel and copper are particularly preferred.

The shape of the electrode substrate 11 is not particularly limited and may be appropriately selected according to the purpose.

The size of the electrode substrate 11 is not particularly limited if it can be applied to the electrochemical device, and can be appropriately selected according to the purpose.

<Liquid Composition for Insulating Layer>

Liquid compositions for insulating layers include inorganic particles having insulating properties and solvents.

Examples of the material constituting the inorganic particles having insulating properties include metal oxides, metal nitrides, other metal compounds, and the like.

Examples of the metal oxide include Al₂O₃, TiO₂, BaTiO₃, ZrO₂, and the like.

Examples of commercially available alumina include AA-05, AKP-3000 (manufactured by Sumitomo Chemical Co., Ltd.), and the like.

Examples of metal nitrides include aluminum nitride, silicon nitride, and the like.

Other metallic compounds include, for example, sparingly soluble ionic crystals such as aluminum fluoride, calcium fluoride, barium fluoride, barium sulfate, magnesium hydroxide, and the like, mineral resource-derived materials such as boehmite, zeolite, apatite, kaolin, mullite, spinel, olivine, sericite, bentonite, and the like, or artifacts thereof.

Other materials containing inorganic particles having insulating properties include glass ceramics.

Examples of glass ceramics include crystallized glass ceramics using crystallized glass of the ZnO—MgO—Al₂O₃—SiO₂, non-glass ceramics using BaO—Al₂O₃—SiO₂ ceramics, Al₂O₃—CaO—SiO₂—MgO—B₂O₃ ceramics, and the like.

The diameter of the insulating inorganic particle is preferably 10 μm or less, and more preferably 3 μm or less.

A solvent is not particularly limited as long as the solvent is capable of dispersing the inorganic particles having insulating property. Examples of solvent include water, a hydrocarbon-based solvent, an alcohol-based solvent, a ketone-based solvent, an ester-based solvent, and an ether-based solvent.

Examples of solvents include, for example, water, N-methyl-2-pyrrolidone (NMP), dimethyl sulfoxide (DMSO), ethyl lactate (EL), methyl ethyl ketone (MEK), 2-heptanone, diacetone alcohol (DAA), isopropyl alcohol (IPA), diisobutyl ketone, cyclohexanone, butyl acetate, isopropyl glycol (IPG), propylene glycol (PG), ethylene glycol (EG), hexylene glycol (HG), 1-propoxy-2-propanol (PP), 2-pyrrolidone, triethylene glycol, diethylene glycol monomethyl ether, diethylene glycol monoethyl ether, and the like.

The liquid composition for insulating layer may further contain dispersant, binder resins, thickening agents, and the like, as needed.

Examples of commercially available dispersing agents include Mega Fac F444 (manufactured by DIC Corporation), Maria Lim HKM-150A, SC-0708A (manufactured by NOF Corporation), Dispersed BYK103 (manufactured by BYK-Chemie GmbH), and the like.

Examples of the binder resin include acrylic resins, styrene-butadiene resins, polyvinylidene fluoride resins, and the like.

Examples of commercially available binder resins include TRD-103A (manufactured by JSR Corporation) and BM-400B (manufactured by ZEON Corporation).

Examples of thickeners include propylene glycol, carboxymethylcellulose, and the like.

The viscosity of the liquid composition for insulating layer is preferably in the range of 5 to 30 mPa·s and more preferably in the range of 10 to 20 mPa·s.

The surface tension of the liquid composition for insulating layer is preferably in the range of 20 to 50 mN/m and more preferably in the range of 30 to 40 mN/m.

<Method of Manufacturing Liquid Compositions for Insulating Layers>

A liquid composition for an insulating layer can be prepared, for example, by dispersing inorganic particles having insulating properties in solvent A to obtain a dispersion liquid, and then diluting the dispersion liquid with solvent B.

Examples of the solvent A include water, N-methyl-2-pyrrolidone (NMP), dimethyl sulfoxide (DMSO), ethyl lactate (EL), methyl ethyl ketone (MEK), 2-heptanone, diacetone alcohol (DAA), isopropyl alcohol (IPA), diisobutyl ketone, cyclohexanone, butyl acetate, and the like.

At this time, the dispersant may be first dissolved in solvent A.

The content of the inorganic particles having insulating property in the dispersion liquid is preferably 40 to 70% by mass.

Examples of the dispersion device used to disperse the insulating inorganic particles in the solvent A include a high-speed rotating shear agitator, an ultrasonic disperser, a bead mill disperser, a high-pressure injection disperser, and the like.

Examples of the solvent B include isopropyl glycol (IPG), propylene glycol (PG), ethylene glycol (EG), hexylene glycol (HG), 1-propoxy-2-propanol (PP), 2-pyrrolidone, triethylene glycol, diethylene glycol, diethylene glycol monomethyl ether, diethylene glycol monoethyl ether, and the like.

At this time, the binder resin may be added to solvent B.

The content of the insulating inorganic particles in the liquid composition for insulating layer is preferably 15 to 45% by mass.

<Liquid Composition for Electrode Composite Material Layer>

The liquid composition for the electrode composite material layer contains an active material and a dispersion medium, and may optionally further contain a conductive aid, a dispersant, and the like.

The electrode composite material layer 12 can be formed by applying a liquid composition for the electrode composite material layer onto the electrode substrate 11.

Examples of the method for applying the liquid composition for the electrode composite material layer include a comma coater method, a die coater method, a curtain coater method, a spray coater method, a liquid discharge method, and the like.

<Active Materials>

As an active material, a positive-electrode active material or a negative-electrode active material may be used.

A positive-electrode active material is not particularly limited as long as the positive-electrode active material can be intercalating or de-intercalating alkali metal ions. Alkali metal-containing transition metal compounds may be used as a positive-electrode active material.

Examples of alkali metal-containing transition metal compounds include lithium-containing transition metal compounds such as complex oxides containing lithium and one or more elements selected from the group consisting of cobalt, manganese, nickel, chromium, iron, and vanadium.

Examples of lithium-containing transition metal compounds include lithium cobalt oxide, lithium nickel oxide, lithium manganese oxide, and the like.

As the alkali metal-containing transition metal compound, a polyanionic compound having an XO₄ tetrahedra (X=P, S, As, Mo, W, Si, and the like) in the crystalline structure may also be used. Among these, lithium-containing transition metal phosphate compounds, such as lithium iron phosphate and lithium vanadium phosphate, are preferred from the viewpoint of cycle characteristics, and vanadium lithium phosphate is particularly preferred from the viewpoint of lithium diffusion coefficient and output characteristics.

It is preferable that the surface of the polyanionic-based compound is coated with a conductive aid such as a carbon material and composited in terms of electron conductivity.

For example, as the alkali metal-containing transition metal compound, a lithium Ni composite oxide having LiNi_{X}Co_{Y}Mn_{Z}O₂ (x+y+z=1) or a lithium phosphate-based material having Li_{X}Me_{Y}(PO₄)_{Z} (0.5≤x≤4, Me=transition metal, 0.5≤y≤2.5, 0.5≤x≤3.5) as the basic structure can be used.

Examples of lithium Ni composite oxides that are LiNi_{X}Co_{Y}Mn_{Z}O₂ (x+y+z=1) include LiNi_{0.33}Co_{0.33}Mn_{0.33}O₂, LiNi_{0.5}Co_{0.2}Mn_{0.3}O₂, LiNi_{0.6}Co_{0.2}Mn_{0.2}O₂, and LiNi_{0.8}Co_{0.2}Mn₀O₂.

Examples of lithium phosphate-based materials having Li_{X}Me_{Y}(PO₄)_{Z} (0.5≤x≤4, Me=transition metal, 0.5≤y≤2.5, 0.5≤x≤3.5) as the basic structure include vanadium lithium phosphate (Li₃V₂(PO₄)₃), olivine iron (LiFePO₄), olivine manganese (LiMnPO₄), olivine cobalt (LiCoPO₄), olivine nickel (LiNiPO₄), and olivine vanadium (LiVOPO₄), similar compounds doped with heterogeneous elements as the basic structure.

A negative-electrode active material is not particularly limited as long as the negative-electrode active material can be intercalating or de-intercalating alkali metal ions. A carbon material containing graphite having a graphite crystalline structure can be used.

Examples of the carbon material include natural graphite, artificial graphite, graphite such as coke, non-graphitizing carbon (hard carbon), graphitizing carbon (soft carbon), amorphous carbon, and the like. Among these, artificial graphite, natural graphite, and amorphous carbon are particularly preferably used.

Examples of the negative-electrode active material other than the carbon material include lithium titanate, titanium oxide, and the like.

High-capacity materials such as silicon, tin, silicon alloy, tin alloy, silicon oxide, silicon nitride, tin oxide, and the like are preferably used as the negative-electrode active material in terms of energy density of the non-aqueous storage device.

<Dispersion Medium>

Examples of the dispersion medium include water, ethylene glycol, propylene glycol, N-methyl-2-pyrrolidone, 2-pyrrolidone, cyclohexanone, butyl acetate, mesitylene, 2-n-butoxymethanol, 2-dimethylethanol, N,N-dimethylacetamide, and the like. Two or more kinds of dispersion medium may be used in combination.

<Conductive Aids>

Examples of the conductive aid include a conductive carbon black manufactured by a furnace method, an acetylene method, and a gasification method, or carbon materials such as carbon nanofibers, carbon nanotubes, graphene, graphite particles, and the like. Examples of the conductive aid other than the carbon materials include metal particles such as aluminum and the like or metal fibers. The conductive aids may be pre-complexed with the active material.

<Dispersant>

Examples of the dispersant include polymer dispersants such as a polycarboxylic acid-based dispersant, a naphthalene sulfonate-based formalin condensation-based dispersant, a polyethylene glycol, a polycarboxylic acid-partial alkyl ester-based dispersant, a polyether-based dispersant, a polyalkylene polyamine-based dispersant, and the like; surfactants such as an alkyl sulfonate-based dispersant, a quaternary ammonium salt-based dispersant, a high-grade alcohol alkylene oxide-based dispersant, a polyhydric alcohol ester-based dispersant, an alkyl polyamine-based dispersant; and inorganic dispersants such as a polyphosphate-based dispersant and the like.

<Method of Manufacturing Electrode>

The method of manufacturing the electrode 10 includes forming the electrode composite material layer 12 on the electrode substrate 11 and forming the insulating layer 13 on the electrode composite material layer 12.

When forming the insulating layer 13, droplets 13a of 5 to 40 pL of the liquid composition are discharged from the liquid discharge head, and the liquid discharge head has a discharge resolution of 300 dpi or more in the nozzle direction and has a discharge resolution of 600 dpi or more in the moving direction. This allows the size of the droplets 13a of the liquid composition and the distance in the moving direction of the liquid discharge head to be controlled to form the insulating layer 13 with an average distribution of micro gaps 14.

The size of the droplets 13a of the liquid composition can be controlled by single, double, or triple pulses of the voltage pattern when discharging the droplets 13a of the liquid composition from the liquid discharge head. Using double or triple pulses doubles or triples the capacity of the reference droplets of single pulse.

The size of droplets 13a of the liquid composition can also be finely adjusted by adjusting the amplitude of the voltage pattern when discharging droplets 13a of the liquid composition from the liquid discharge head.

The spacing of the liquid discharge head in the moving direction of the droplets 13a of the liquid composition can be controlled by adjusting the number of times the voltage pattern is applied when the droplets 13a of the liquid composition are discharged from the liquid discharge head. Here, the moving direction of the liquid discharge head is a direction in which the liquid discharge head moves directly or relatively to the electrode substrate, and the moving direction is perpendicular to the to the nozzle direction. By adjusting the spacing in the moving direction of the liquid discharge head of the droplets 13a of the liquid composition, that is, the density of the droplets 13a of the liquid composition, the average value of the coverage percentage of the electrode composite material layer 12 by the insulating layer 13 can easily be adjusted.

<Method of Manufacturing Negative-Electrode>

FIG. 6 illustrates an example of a method of manufacturing the negative-electrode according to the present embodiment.

A method of manufacturing the negative-electrode includes discharging a liquid composition 12A for the negative-electrode composite material layer onto the negative-electrode substrate 11 using a liquid discharge device 300 to form the negative-electrode composite material layer 12, and discharging the liquid composition for the insulating layer onto the negative-electrode composite material layer 12 to form the insulating layer.

The liquid composition 12A for the negative-electrode composite material layer contains a negative-electrode active material and a dispersion medium.

The liquid composition 12A for the negative-electrode composite material layer is stored in a tank 307 and supplied from the tank 307 through a tube 308 to a liquid discharge head 306.

The liquid discharge device 300 may also be provided with a mechanism to cap the nozzle to prevent drying when the liquid composition 12A for the negative-electrode composite material layer is not discharged from the liquid discharge head 306.

In manufacturing the negative-electrode, the negative-electrode substrate 11 is placed on a stage 400 that can be heated. Then, the droplets of the liquid composition 12A for the negative-electrode composite material layer are discharged to the negative-electrode substrate 11, and then heated to form the negative-electrode composite material layer 12. The stage 400 may then move, and the liquid discharge head 306 may move.

When the liquid composition 12A for the negative-electrode composite material layer discharged to the negative-electrode substrate 11 is heated, it may be heated by the stage 400 or by a heating mechanism other than the stage 400.

Heating mechanisms include, for example, resistive heaters, infrared heaters, fan heaters, and the like, without direct contact with the liquid composition 12A for the negative-electrode composite material layer.

A plurality of heating mechanisms may be provided.

The heating temperature is not particularly limited, but preferably in the range of 70 to 150&ordm;C from the viewpoint of energy use.

A UV light may also be emitted when the liquid composition 12A discharged to the negative-electrode substrate 11 is heated.

Next, an insulating layer is formed in the same manner as the negative electrode composite material layer 12 to prepare a negative-electrode.

FIG. 7 illustrates another example of a method of manufacturing a negative-electrode according to the present embodiment.

A method of manufacturing the negative-electrode includes discharging the liquid composition 12A for the negative-electrode composite material layer onto the negative-electrode substrate 11 using the liquid discharge device 300 to form the negative-electrode composite material layer 12, and discharging the liquid composition for the insulating layer onto the negative-electrode composite material layer 12 to form the insulating layer.

First, an elongate negative-electrode substrate 11 is prepared. Then, the negative-electrode substrate 11 is wound around a cylindrical core, and the side forming the negative-electrode composite material layer 12 is set to a feed roller 304 and a take-up roller 305 so as to be on the upper side in the drawing. Here, the feed roller 304 and the take-up roller 305 rotate counterclockwise, and the negative-electrode substrate 11 is conveyed from the right to the left direction in the drawing. The droplets of the liquid composition 12A for the negative electrode composite material layer are discharged from the liquid discharge head 306 placed above the negative-electrode substrate 11 between the feed roller 304 and the take-up roller 305 onto the negative-electrode substrate 11 to be conveyed. The droplets of the liquid composition 12A for the negative-electrode composite material layer are discharged over at least a portion of the negative-electrode substrate 11.

A plurality of liquid discharge heads 306 may be placed in a direction substantially parallel to or substantially perpendicular to the conveying direction of the negative-electrode substrate 11.

Next, the negative-electrode substrate 11 on which the liquid composition 12A for the negative-electrode composite material layer is discharged is conveyed to a heating mechanism 309 by the feed roller 304 and the take-up roller 305. As a result, the liquid composition 12A for the negative-electrode composite material layer on the negative-electrode substrate 11 is dried to form the negative-electrode composite material layer 12.

The heating mechanism 309 is not particularly limited. Examples of heating mechanism include, for example, resistive heaters, infrared heaters, fan heaters, and the like, without direct contact with the liquid composition 12A for the negative-electrode composite material layer.

The heating mechanism 309 may be provided on one of the upper and lower portions of the negative-electrode substrate 11, or a plurality of the heating mechanisms may be provided.

The heating temperature is not particularly limited, but preferably in the range of 70 to 150° C. from the viewpoint of energy use.

A UV light may also be emitted when the liquid composition 12A discharged to the negative electrode substrate 11 is heated.

Next, an insulating layer is formed in the same manner as the negative electrode composite material layer 12 to prepare a negative-electrode.

Then, the negative-electrode is cut to the desired size by punching or the like.

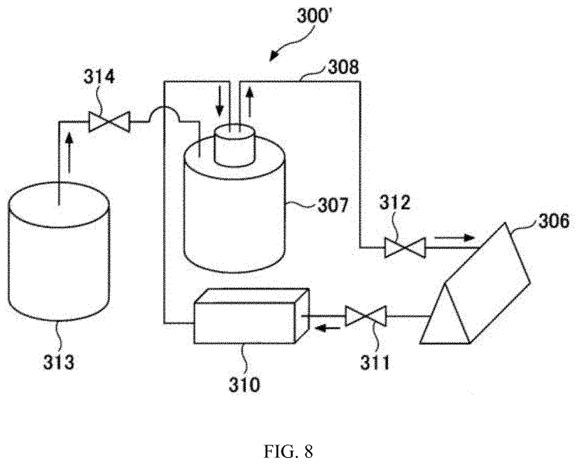

FIG. 8 illustrates a modification example of the liquid discharge device 300.

In a liquid discharge device 300′, the liquid composition for the negative-electrode composite material layer can circulate through the liquid discharge head 306, the tank 307, and the tube 308 by a controlling the pump 310 and valves 311 and 312.

The liquid discharge device 300′ is also provided with an external tank 313, and the liquid composition 12A for the negative-electrode composite material layer can be supplied from the external tank 313 to the tank 307 by controlling the pump 310 and the valves 311, 312, and 314 when the liquid composition 12A for the negative-electrode composite material layer in the tank 307 is reduced.

The liquid discharge devices 300 and 300′ can be used to discharge the liquid composition 12A for the negative-electrode composite material layer at the target of the negative-electrode substrate 11. Further, when the liquid discharge devices 300 and 300′ are used, surfaces that contact the upper and lower portions of the negative-electrode substrate 11 and the negative-electrode composite material layer 12 can be bonded to each other. Furthermore, the thickness of the negative-electrode composite material layer 12 can be uniform using the liquid discharge devices 300 and 300′.

<Method of Manufacturing Positive-Electrode>

The method of manufacturing the positive-electrode is the same as that of the negative-electrode, except that the liquid composition for the positive-electrode composite material layer including the positive-electrode active material and the dispersion medium is discharged on the positive-electrode substrate.

The insulating layer may be formed in at least one of the positive-electrode or the negative-electrode.

<Electrochemical Device>

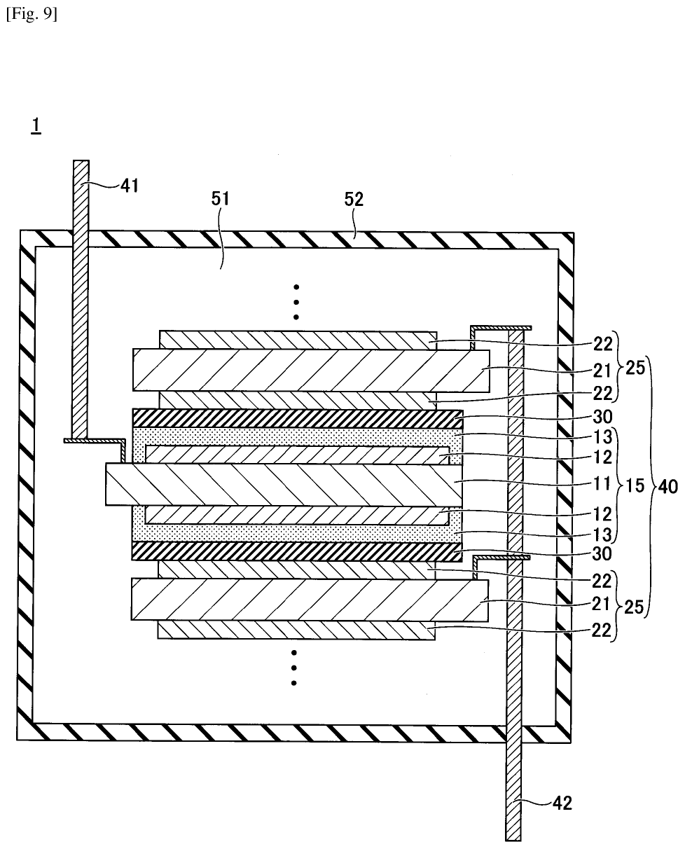

FIG. 9 illustrates an example of an electrochemical device of the present embodiment.

In an electrochemical device 1, an electrolyte layer 51 made of an electrolyte aqueous solution or a non-aqueous electrolyte is formed on an electrode element 40 and sealed by an outer sheath 52. In the electrochemical device 1, lead lines 41 and 42 are drawn out of the outer sheath 52.

In the electrode element 40, a negative-electrode 15 and a positive-electrode 25 are laminated through a separator 30. Here, the positive-electrode 25 is laminated to both sides of the negative-electrode 15. The lead line 41 is connected to the negative-electrode substrate 11, and the lead line 42 is connected to a positive-electrode substrate 21.

In the negative-electrode 15, the negative-electrode composite material layer 12 and the insulating layer 13 are sequentially formed on both sides of the negative-electrode substrate 11.

The average thickness of the negative-electrode composite material layer 12 is preferably 10 to 450 μm and more preferably 20 to 100 μm. When the average thickness of the negative-electrode composite material layer 12 is 10 μm or more, the energy density of the electrochemical device 1 is improved. When the average thickness of the negative-electrode composite material layer 12 is 450 μm or less, the cycle characteristic of the electrochemical device 1 is improved.

In the positive-electrode 25, a positive-electrode composite material layer 22 is formed on both sides of the positive-electrode substrate 21.

The average thickness of the positive-electrode composite material layer 22 is preferably 10 to 300 μm and more preferably 40 to 150 μm. When the average thickness of the positive-electrode composite material layer 22 is 20 μm or more, the energy density of the electrochemical device 1 is improved. When the average thickness of the positive-electrode composite material layer 22 is 300 μm or less, the load characteristic of the electrochemical device 1 is improved.

Here, the positive-electrode composite material layer 22 and the insulating layer may be sequentially formed on both surfaces of the positive-electrode substrate 21. In this case, the insulating layer 13 may be omitted as needed.

The number of layers of the negative-electrode 15 and the positive-electrode 25 of the electrode element 40 is not particularly limited.

The number of the negative-electrode 15 and the number of the positive-electrode 25 of the electrode element 40 may be the same or may be different.

The electrochemical device 1 may have other parts as desired.

The type of the electrochemical device 1 is not particularly limited. Examples of the electrochemical device 1 include a laminate type, a cylinder type in which a sheet electrode and a separator are spiraled, a cylinder type with an inside-out structure in which a pellet electrode and a separator are combined, and a coin type in which a pellet electrode and a separator are laminated.

Examples of the electrochemical device 1 include a water-based battery device and a non-water-based battery device.

<Separator>

A separator 30 is provided between the negative-electrode 15 and the positive-electrode 25 as needed to prevent short circuiting of the negative-electrode 15 and the positive-electrode 25.

Examples of the separator 30 include paper such as kraft paper, vinylon mixed paper, synthetic pulp mixed paper, polyolefin non-woven fabric such as cellophane, polyethylene graft film, polypropylene meltblown non-woven fabric, polyamide non-woven fabric, glass fiber non-woven fabric, micropore membrane, and the like.

The size of the separator 30 is not particularly limited if the separator can be used in electrochemical devices.

The separator 30 may be a single layer structure or a laminated structure.

When a solid electrolyte is used as a non-aqueous electrolyte, the separator 30 may be omitted.

<Electrolyte Solution>

Examples of the electrolyte salt constituting the aqueous electrolyte solution include sodium hydroxide, potassium hydroxide, sodium chloride, potassium chloride, ammonium chloride, zinc chloride, zinc acetate, zinc bromide, zinc iodide, zinc tartrate, zinc perchlorate, and the like.

<Non-Aqueous Electrolyte>

As the non-aqueous electrolyte, a solid electrolyte or a non-aqueous electrolyte may be used.

Here, the non-aqueous electrolyte solution is an electrolyte solution in which the electrolyte salt is dissolved in the non-aqueous solvent.

<Non-Aqueous Solvents>

A non-aqueous solvent is not particularly limited. For example, an aprotic organic solvent is preferably used.

As the aprotic organic solvent, carbonate-based organic solvents such as a chain carbonate or a cyclic carbonate may be used. Of these, a chain carbonate is preferably used because of the high solubility of the electrolyte salt.

Preferably, the aprotic organic solvent has a low viscosity.

Examples of the chain carbonate include dimethyl carbonate (DMC), diethyl carbonate (DEC), methyl ethyl carbonate (EMC), and the like.

The content of the chain carbonate in the non-aqueous solvent is preferably 50% by mass or more. When the content of the chain carbonate in the non-aqueous solvent is 50% by mass or more, the content of cyclic material is reduced even when the non-aqueous solvent other than the chain carbonate is a cyclic material with a high dielectric constant (e.g., cyclic carbonate, cyclic ester). Therefore, even when a non-aqueous electrolytic solution having a high concentration of 2 M or more is prepared, the viscosity of the non-aqueous electrolytic solution decreases, and impregnation and ion diffusion into the electrode of the non-aqueous electrolytic solution becomes favorable.

Examples of the cyclic carbonate include propylene carbonate (PC), ethylene carbonate (EC), butylene carbonate (BC), vinylene carbonate (VC), and the like.

The non-aqueous solvent other than the carbonate organic solvent includes, for example, ester-based organic solvents such as a cyclic ester or a chain ester, ether-based organic solvents such as a cyclic ether or a chain ether, and the like.

Examples of cyclic esters include γ-butyrolactone (γBL), 2-methyl-γ-butyrolactone, acetyl-γ-butyrolactone, γ-valerolactone, and the like.

Examples of chain esters include propionic acid alkyl ester, malonic acid dialkyl ester, acetic acid alkyl ester (e.g., methyl acetate (MA), ethyl acetate), formic acid alkyl ester (e.g., methyl formate (MF), ethyl formate), and the like.

Examples of cyclic ethers include tetrahydrofuran, alkyltetrahydrofuran, alkoxytetrahydrofuran, dialkoxytetrahydrofuran, 1,3-dioxolane, alkyl-1,3-dioxolane, 1,4-dioxolane, and the like.

Examples of chain ethers include 1,2-dimethoxyethane (DME), diethyl ether, ethylene glycol dialkyl ether, diethylene glycol dialkyl ether, triethylene glycol dialkyl ether, tetraethylene glycol dialkyl ether, and the like.

<Electrolyte Salt>

An electrolyte salt is not particularly limited, as long as the electrolyte salt has high ionic conductivity and can be dissolved in a non-aqueous solvent.

The electrolyte salt preferably contains a halogen atom.

Examples of the cations constituting the electrolyte salt include lithium ions and the like.

Examples of the anions constituting the electrolyte salt include BF₄⁻, PF₆⁻, AsF₆⁻, CF₃SO₃⁻, (CF₃SO₂)₂N⁻, (C₂F₅SO₂)₂N⁻, and the like.

The lithium salts are not particularly limited and can be appropriately selected according to the purpose. Examples of the lithium salts include lithium hexafluorophosphate (LiPF₆), lithium borofluoride (LiBF₄), lithium arsenide (LiAsF₆), lithium trifluorometasulfonate (LiCF₃SO₃), lithium bis (trifluoromethylsulfonyl) imide (LiN(CF₃SO₂)₂), lithium bis (pentafluoroethylsulfonyl) imide (LiN(C₂F₅SO₂)₂), and the like. Among these, LiPF₆ is preferably used from the viewpoint of ionic conductivity, and LiBF₄ is preferably used from the viewpoint of stability.

The electrolyte salt may be used alone or two or more kinds may be used in combination.

The concentration of the electrolyte salt in the non-aqueous electrolyte solution can be appropriately selected according to the purpose. When the non-aqueous battery device is of the swing type, the concentration of the electrolyte salt is preferably 1 mol/L to 2 mol/L. When the non-aqueous battery device is of the reservoir type, the concentration of the electrolyte salt is preferably 2 mol/L to 4 mol/L.

<Application of Electrochemical Devices>

Applications of electrochemical devices include, but are not limited to, notebook PCs, pen input PCs, mobile PCs, electronic book players, cellular phones, portable faxes, portable copies, portable printers, headphone stereos, video movies, LCD TVs, handy cleaners, portable CDs, mini disks, transceivers, electronic pocketbooks, calculators, memory cards, portable tape recorders, radio, backup power supplies, motors, lighting fixtures, toys, game machines, clocks, strobe boxes, cameras, and the like.

### EXAMPLES

Hereinafter, examples of the present invention will be described, but the present invention is not limited by the examples. “Parts” and “%” are by mass unless otherwise indicated.

<Preparation of Liquid Compositions for Insulating Layers>

The alumina particles were dispersed in solvent A, previously dissolved in a dispersant, and then diluted with solvent B to give liquid compositions 1 to 16 for the insulating layer. At this time, in preparing the liquid compositions for the insulating layer 8 and 9, solvent B in which the binder resin was previously dissolved was used.

Table 1 illustrates the compositions of the liquid compositions 1 to 16 for the insulating layer.

TABLE 1

| | Alumina particles | | Solvent A | | Solvent B | | Dispersant | | Binder resin | |
|---|---|---|---|---|---|---|---|---|---|---|
| | | Content | | Content | | Content | | Content | | Content |
| Liquid | | [% by | | [% by | | [% by | | [% by | | [% by |
| composition | Type | mass] | Type | mass] | Type | mass] | Type | mass] | Type | mass] |
| 1 | AKP-3000 | 30 | Water | 29.09 | PG | 40 | HKM-150A | 0.75 | — | — |
| | | | | | | | F444 | 0.16 | | |
| 2 | AKP-3000 | 30 | NMP | 29.1 | EG | 40 | HKM-150A | 0.9 | — | — |
| 3 | AKP-3000 | 30 | DMSO | 29.1 | PG | 30 | HKM-150A | 0.9 | — | — |
| | | | | | PP | 10 | | | | |
| 4 | AA-05 | 30 | DMSO | 29.3 | PG | 30 | HKM-150A | 0.7 | — | — |
| | | | | | PP | 10 | | | | |
| 5 | AKP-3000 | 40 | EL | 35.4 | HG | 22.6 | SC-0708A | 2 | — | — |
| 6 | AKP-3000 | 40 | EL | 36.2 | HG | 22.6 | SC-0708A | 1.2 | — | — |
| 7 | AKP-3000 | 40 | EL | 34.2 | HG | 21.8 | BYK103 | 4 | — | — |
| 8 | AKP-3000 | 40 | EL | 34.4 | HG | 22.6 | SC-0708A | 2 | TRD-104A | 1 |
| 9 | AKP-3000 | 40 | EL | 34.4 | HG | 22.6 | SC-0708A | 1.6 | BM-400B | 1 |
| 10 | AA-05 | 40 | EL | 35.8 | HG | 22.6 | SC-0708A | 2 | | — |
| 11 | AKP-3000 | 40 | DAA | 35.8 | HG | 22.6 | SC-0708A | 2 | | — |
| 12 | AKP-3000 | 40 | DAA | 35.8 | 2-pyrrolidone | 22.6 | SC-0708A | 2 | | — |
| 13 | AKP-3000 | 40 | IPA | 35.8 | HG | 22.6 | SC-0708A | 2 | | — |
| 14 | AKP-3000 | 40 | IPA | 35.8 | 2-pyrrolidone | 22.6 | SC-0708A | 2 | | — |
| 15 | AKP-3000 | 40 | 2-heptanone | 35.8 | HG | 22.6 | SC-0708A | 2 | | — |
| 16 | AKP-3000 | 40 | 2-heptanone | 35.8 | 2-pyrrolidone | 22.6 | SC-0708A | 2 | | — |

### Examples 1 to 8, Comparative Examples 2 and 3

<<Preparation of Negative-Electrode>>

A slurry for the negative-electrode composite material layer obtained by mixing and kneading the negative-electrode active material SCMG-XRs (manufactured by Showa Denko K. K.), water, and resin was applied to both surfaces of the copper foil as the negative-electrode substrate using a comma coater, and then dried to form the negative-electrode composite material layer. Then, after pressing at a force of about 100 kN, the liquid discharge device EV2500 (manufactured by Ricoh Co., Ltd.) and the liquid discharge head MH5421F (manufactured by Ricoh Co., Ltd.) were used to discharge the liquid composition for the insulating layer onto the negative-electrode composite material layer, and the insulating layer was formed to obtain the negative-electrode.

<<Preparation of Positive-Electrode>>

A slurry for the positive-electrode composite material layer obtained by mixing and kneading the positive-electrode active material lithium nickelate 503H (made of JFE Mineral Co., Ltd.), N-methylpyrrolidone, and resin was applied to both surfaces of the aluminum foil as the positive-electrode substrate using a comma coater, and then dried to form the positive-electrode composite material layer. From this, the positive-electrode was obtained.

<<Preparation of Non-Aqueous Electrolyte>>

Lithium hexafluorophosphate (LiPF₆) and lithium borofluoride (LiBF₄) were dissolved in ethylene carbonate to obtain a non-aqueous electrolyte.

<<Preparation of Lithium Ion Secondary Batteries>>

Two positive-electrodes and one negative-electrode were laminated through a separator made of cellulose with a thickness of 16 μm without overlapping the positive-electrode lead line and the negative-electrode lead line, and an electrode element was obtained. Next, the electrode elements were sandwiched between the laminated films, and then the laminated seal was used to form a bag-like sheath. Then, after the non-aqueous electrolyte was injected into the outer package, the injection portion was sealed, and a lithium-ion secondary battery was obtained (see FIG. 9).

### Comparative Examples 1-1 to 1-4

<<Preparation of Negative-Electrode>>

A slurry for the negative-electrode composite material layer obtained by mixing and kneading the negative-electrode active material SCMG-XRs (manufactured by Showa Denko K. K.), water, and resin was applied to both surfaces of the copper foil as the negative-electrode substrate using a comma coater, and then dried to form the negative-electrode composite material layer to obtain the negative-electrode. That is, the negative-electrodes of Comparative Examples 1-1 to 1-4 were different from the negative-electrodes of Examples 1 to 8 and Comparative Examples 2 and 3 in that no insulating layers were formed.

The lithium ion secondary batteries of Comparative Examples 1-1 to 1-4 were obtained in the same manner as Examples 1 to 8, Comparative Examples 2 and 3, except that the negative-electrodes in which the obtained insulating layers were not formed.

Note that, the lithium ion secondary batteries of Comparative Examples 1-1 to 1-4 were manufactured at the same timing as the lithium ion secondary batteries of the contrasting examples, although the configuration was the same.

Next, the output, output retention rate, and safety of the lithium ion secondary batteries were evaluated.

<<Output of Lithium Ion Secondary Battery>>

A charge and discharge test were performed to evaluate the output of a lithium ion secondary battery. Specifically, the lithium ion secondary battery was adjusted to a predetermined SOC by discharging a constant current for 10 minutes at a current rate of 1 C. Next, after a constant current discharge for 10 seconds at a pulse of current rate 1 C, a 30-minute pause was performed. Then, a constant current charge was performed for 10 seconds at current rate 1 C. Subsequently, a 30-minute pause was performed, and a constant current charge and discharge were repeated for 10 seconds at current rates 3 C and 5 C at similar time intervals.

The output [W] was calculated by calculating the constant current value at 2.5 V which is a discharge cut-off voltage as the linear approximation of each constant current discharge cut-off voltage, and multiplying the constant current value by 2.5 V.

<<Retention Rate of Lithium ion Secondary Battery>>

The output of lithium ion secondary battery in Comparative Examples 2 and Examples 1 to 3 were divided by the output of lithium ion battery in Comparative Examples 1-1 to obtain the output retention rate.

The output of lithium ion secondary battery in Comparative Examples 3 and Examples 4 and 5 were divided by the output of lithium ion battery in Comparative Examples 1-2 to obtain the output retention rate.

The output of lithium ion secondary battery in Example 6 was divided by the output of lithium ion battery in Comparative Examples 1-3 to obtain the output retention rate.

<<Safety of Lithium ion Secondary Battery>>

A nail prick test was conducted to evaluate the safety of lithium ion secondary batteries. Specifically, after the lithium ion battery was fully charged (SOC 100%), the safety was evaluated with the presence or absence of ignition by intentionally short-circuiting by stabbing the lithium ion secondary battery with the nail having a diameter of 4.5 m. The nail was perpendicularly stabbed to the direction where the electrodes were laminated.

The safety of lithium ion secondary batteries was determined based on the following criteria.

A: Did not ignite

B: Ignited

Table 2 indicates the output, output retention rate, and safety evaluation results for lithium ion secondary batteries.

TABLE 2

| | | | | | | Insulating layer | | | | |
|---|---|---|---|---|---|---|---|---|---|---|
| | | | | | | Average | | | | |
| | | | | | | value of | | | | |
| | | Discharge resolution [dpi] | | | Volume | the | | | | |
| | | | Moving direction | Drive | of | coverage | Basis | | Output | |
| | Liquid | Nozzle | of liquid | voltage | droplets | percentage | weight | Output | retention | |
| | composition | direction | discharge head | [V] | [pL] | [%] | [mg/cm²] | [W] | rate [%] | Safty |
| Comparative | — | — | — | — | — | — | — | 12.9 | — | B |
| Example 1-1 | | | | | | | | | | |
| Comparative | 1 | 600 | 2200 | 16 | 10 | 88.0 | 0.6 | 13.1 | 101.6 | B |
| Example 2 | | | | | | | | | | |
| Example 1 | 1 | 600 | 3000 | 16 | 10 | 92.5 | 0.8 | 12.5 | 96.9 | A |
| Example 2 | 1 | 600 | 4800 | 16 | 10 | 94.5 | 1.3 | 12.6 | 97 7 | A |
| Example 3 | 1 | 1200 | 4800 | 16 | 10 | 100.0 | 2.7 | 12.6 | 97.7 | A |
| Comparative | — | — | — | — | — | — | — | 12.7 | — | B |
| Example 1-2 | | | | | | | | | | |
| Comparative | 3 | 600 | 1200 | 15 | 20 | 89.0 | 0.5 | 12.2 | 96.1 | B |
| Example 3 | | | | | | | | | | |
| Example 4 | 3 | 1200 | 1200 | 15 | 20 | 95.0 | 1.0 | 12.2 | 96.1 | A |
| Example 5 | 3 | 1200 | 2400 | 15 | 20 | 99.0 | 2.0 | 12.4 | 97.6 | A |
| Comparative | — | — | — | — | — | — | — | 13.1 | — | B |
| Example 1-3 | | | | | | | | | | |
| Example 6 | 5 | 600 | 1200 | 21 | 20 | 96.7 | 1.0 | 12.8 | 97.7 | A |

From Table 2, the lithium ion secondary batteries of Examples 1 to 6 satisfied both safety and output.

In contrast, the lithium ion secondary batteries of Comparative Examples 1 to 3 were less safe than the lithium ion secondary batteries of Examples 1 to 6 because the average value of the coverage percentage of the negative electrode composite material layers by the insulating layers were less than 90%.

In Examples 1 to 4, the average value of the coverage percentage values of the negative electrode composite material layers by the insulating layers were controlled from 88.0% to 100.0% by fixing the droplet capacity to 10 pL and adjusting the discharge resolution in the nozzle direction and the moving direction of the liquid discharge head. In Examples 5 and 6, the average value of the coverage percentage values of the negative electrode composite material layers by the insulating layers were controlled from 89.0% to 99.0% by fixing the droplet capacity to 20 pL and adjusting the discharge resolution in the nozzle direction and the moving direction of the liquid discharge head. In this way, by adjusting the discharge resolution in the nozzle direction and the moving direction of the liquid discharge head, the average value of the coverage ratio of the negative electrode composite material layer by the insulating layer can be easily controlled.

Although the output of the lithium ion secondary battery of Examples 1 to 3 was slightly reduced but negligible level with respect to Comparative Examples 1-1. The same were applied to the lithium ion secondary batteries of Examples 4 to 6.

Here, the thickness of the insulating layer of the lithium ion secondary battery of Examples 1 to 6 was 5 to 10 μm and the thickness of the separator was 16 μm. Therefore, the distance between the positive and negative-electrodes of the lithium ion secondary batteries of Comparative Examples 1-1 to 1-3 was 16 μm, while the distance between the positive and negative-electrodes of the lithium ion secondary batteries of Examples 1 to 6 and Comparative Examples 2 and 3 were 21 to 26 μm because the distance was greater by the thickness of the insulating layer. As a result, the output of the lithium ion secondary batteries of Examples 1 to 6 were reduced. This is due to the increased distance between the positive and negative-electrodes, and is not due to the inhibition of lithium ion movement caused by coating the negative-electrode composite material layer with an insulating layer.

Next, the initial capacity, the capacity after 1000 cycles, and the capacity retention rate of the lithium ion secondary batteries were evaluated.

<<Initial Capacity of Lithium Ion Secondary Battery>>

A test of charging and discharging a lithium ion secondary battery was performed to evaluate the initial capacity of the lithium ion secondary battery. Specifically, after constant current charging to 4.2 V at a current rate of 0.2 C, a current value of 4.2 V (constant) was applied for 10 hours so that the battery was in a fully charged state. Next, a 10-minute pause was performed, and the constant current was discharged to a cut-off voltage of 2.5 V at a current rate of 0.2 C. Then, the initial capacity [mAh] was calculated from the time to reach 2.5 V and the current value.

<<Capacity After 1000 Cycles of Lithium Ion Secondary Battery>>

A test of charging and discharging a lithium ion secondary battery was performed 1000 times, and then the capacity of lithium ion secondary battery after 1000 cycles was evaluated.

<<Capacity Retention Rate>>

The capacity of lithium ion secondary battery after 1000 cycles was divided by the initial capacity of lithium ion secondary battery to obtain the capacity retention rate.

Table 3 indicates the evaluation results of the initial capacity, the capacity after 1000 cycles, the capacity retention rate, and the safety of the lithium ion secondary batteries.

TABLE 3

| | | | | | | Insulating layer | | | | | |
|---|---|---|---|---|---|---|---|---|---|---|---|
| | | | | | | Average | | | | | |
| | | | | | | value of | | | Capacity | | |
| | | Discharge resolution [dpi] | | | Volume | the | | | after | | |
| | | | Moving direction | Drive | of | coverage | Basis | Initial | 1000 | Capacity | |
| | Liquid | Nozzle | of liquid | voltage | droplets | percentage | weight | capacity | cycles | retention | |
| | composition | direction | discharge head | [V] | [pL] | [%] | [mg/cm²] | [mAh] | [mAh] | rate [%] | Safty |
| Comparative | — | — | — | — | — | — | — | 188.0 | 173.0 | 92.0 | B |
| Example 1-4 | | | | | | | | | | | |
| Example 4 | 3 | 1200 | 1200 | 15 | 20 | 95.0 | 1.0 | 186.0 | 169.0 | 90.9 | A |
| Example 6 | 5 | 600 | 1200 | 21 | 20 | 96.7 | 1.0 | 188.0 | 174.2 | 92.7 | A |
| Example 7 | 1 | 600 | 3000 | 20 | 10 | 93.1 | 1.0 | 188.0 | 167.0 | 88.8 | A |
| Example 8 | 6 | 600 | 1200 | 21 | 20 | 95.9 | 1.0 | 188.0 | 171.5 | 91.2 | A |

From Table 3, the lithium ion secondary batteries of Examples 4, 6 to 8 satisfied both safety and capacity retention rate.

In contrast, the lithium ion secondary battery of Comparative Examples 1-4 was less safe than the lithium ion secondary batteries of Examples 4 and 6 to 8 because the negative electrode composite material layers were not covered by insulating layers.

In Examples 4 and 6 to 8, the basis weight of the insulating layers was 1.0 mg/cm², but the average value of the coverage percentage of the negative electrode composite material layers by the insulating layers differ from 93.1% to 96.7%. This is because liquid compositions differ, so the spread of droplets after the droplets reached the negative-electrode composite material layers differ according to the difference in surface tension of the liquid compositions. The higher the average value of the coverage percentage of the negative-electrode composite material layer by the insulating layer, the higher the capacity retention rate of the lithium ion secondary battery, and the lower the capacity of the lithium ion secondary battery after charge and discharge tests in 1000 cycles. When lithium ion secondary batteries are charged and discharged repeatedly, deposits of lithium ions adhere to the negative-electrode and the capacity may decrease. However, coating the negative-electrode with an insulating layer prevents deposits of lithium ions from adhering to the negative-electrode.

### Examples 9 to 11

<<Preparation of Negative-Electrode>>

A slurry for the negative-electrode composite material layer obtained by mixing and kneading the negative-electrode active material SCMG-XRs (manufactured by Showa Denko K. K.), water, and resin was applied on both surfaces of the copper foil as the negative-electrode substrate using a comma coater, and then dried to form the negative-electrode composite material layer to obtain the negative-electrode.

<<Preparation of Positive-Electrode>>

A slurry for the positive-electrode composite material layer obtained by mixing and kneading the positive-electrode active material lithium nickelate 503H (manufactured by JFE Mineral Co., Ltd.), N-methylpyrrolidone, and resin was applied on both surfaces of the aluminum foil as the positive-electrode using a comma coater, and then dried to form the positive-electrode composite material layer. Then, after pressing at a force of about 100 kN, the liquid discharge device EV2500 (manufactured by Ricoh Co., Ltd.) and the liquid discharge head MH5421F (manufactured by Ricoh Co., Ltd.) were used to discharge the liquid composition for the insulating layer onto the positive-electrode composite material layer, and the insulating layer was formed to obtain the positive-electrode.

The lithium ion secondary batteries were obtained in the same manner as Examples 1 to 8 and Comparative Examples 2 and 3, except that the obtained positive and negative-electrodes were used.

### Comparative Example 4

<<Preparation of Positive-Electrode>>

A slurry for the positive-electrode composite material layer obtained by mixing and kneading the positive-electrode active material lithium nickelate 503H (manufactured by JFE Mineral Co., Ltd.), N-methylpyrrolidone, and resin was applied on both surfaces of the aluminum foil as the positive-electrode using a comma coater, and then dried to form the positive-electrode composite material layer to obtain the positive-electrode. That is, the positive-electrode of Comparative Example 4 differs from the positive-electrode of Examples 9 to 11 in that an insulating layer is not formed.

The lithium ion secondary battery in Comparative Example 4 was obtained in the same manner as Examples 9 to 11, except that the obtained positive-electrode was used.

Next, the initial capacity, the capacity after 700 cycles, and the capacity retention rate of the lithium ion secondary battery were evaluated.

<<Initial Capacity of Lithium Ion Secondary Battery>>

A test of charging and discharging a lithium secondary battery was performed to evaluate the initial capacity of the lithium ion secondary battery.

<<Capacity of Lithium Ion Secondary Battery After 700 Cycles>>

A test of charging and discharging the lithium ion secondary battery was performed 700 times, and then the capacity of lithium ion secondary battery after 700 cycles was evaluated.

<<Capacity Retention Rate>>

The capacity of lithium ion secondary battery after 700 cycles was divided by the initial capacity of lithium ion secondary battery to obtain the capacity retention rate.

Table 4 indicates the evaluation results of the initial capacity, the capacity after 700 cycles, the capacity retention rate, and the safety of lithium ion secondary batteries.

TABLE 4

| | | | | | | Insulating layer | | | | | |
|---|---|---|---|---|---|---|---|---|---|---|---|
| | | | | | | Average | | | | | |
| | | | | | | value of | | | | | |
| | | Discharge resolution [dpi] | | | Volume | the | | | Capacity | | |
| | | | Moving direction | Drive | of | coverage | Basis | Initial | after 700 | Capacity | |
| | Liquid | Nozzle | of liquid | voltage | droplets | percentage | weight | capacity | cycles | retention | |
| | composition | direction | discharge head | [V] | [pL] | [%] | [mg/cm²] | [mAh] | [mAh] | rate [%] | Safty |
| Comparative | — | — | — | — | — | — | — | 147.5 | 142.8 | 96.8 | B |
| Example 4 | | | | | | | | | | | |
| Example 9 | 5 | 600 | 900 | 24 | 25 | 97.3 | 1.0 | 144.2 | 138.8 | 96.2 | A |
| Example 10 | 5 | 600 | 1200 | 24 | 25 | 99.4 | 1.3 | 144.4 | 140.4 | 97.2 | A |
| Example 11 | 5 | 1200 | 1200 | 24 | 25 | 99.7 | 2.5 | 143.5 | 138.0 | 96.2 | A |

From Table 4, the lithium ion secondary batteries of Examples 9 to 11 satisfied both safety and capacity retention.

In contrast, the lithium ion secondary battery of Comparative Example 4 was less safe than the lithium ion secondary battery of Examples 9 to 11 because the positive-electrode composite material layer in Comparative Example 4 was not covered by an insulating layer.

From the above, the same effect can be obtained by forming the insulating layer on the positive-electrode composite material layer instead of forming the insulating layer on the negative-electrode composite material layer.

This international application claims priority under Japanese Patent Application No. 2019-209912, filed Nov. 20, 2019, and the entire contents of Japanese Patent Application No. 2019-209912 are incorporated herein by reference.

Although the preferred embodiment has been described in detail above, various modifications and substitutions can be made to the above-described embodiment without departing from the scope of the claims.

### REFERENCE SIGNS LIST

1 Electrochemical device

10 Electrode

11 Electrode (negative-electrode) substrate

12 Electrode (negative-electrode) composite material layer

13 Insulating layer

13a Droplets of liquid composition

14 Micro gaps

15 Negative-electrode

21 Positive-electrode substrate

22 Positive-electrode composite material layer

25 Positive-electrode

30 Separator

40 Electrode element

41, 42 Lead line

51 Electrolyte layer

52 Outer sheath

### CITATION LIST

### Patent Literature

[PTL 1] Japanese Patent No. 3953026

1. An electrode, comprising:
an electrode composite material layer and an insulating layer that are sequentially formed on an electrode substrate; and
the electrode composite material layer is coated by the insulating layer;
wherein an average value of the coverage percentage of the electrode composite material layer by the insulating layer is 90% or more.

2. The electrode according to claim 1, wherein the average value of the coverage percentage of the electrode composite material layer by the insulating layer is 95% or more.

3. The electrode according to claim 1, wherein the insulating layer includes a plurality of dots arranged in a line with micro gaps therebetween, and the insulating layer satisfies a following formula:
Y≤X,
wherein a length and a width of the micro gaps are X[μm] and Y[μm], respectively.

4. The electrode according to claim 3, wherein the formula satisfies Y≤100.

5. The electrode according to claim 3, wherein the micro gaps are periodically formed in a width direction of the micro gaps in the insulating layer.

6. A method of manufacturing an electrode, comprising:
forming an electrode composite material layer on an electrode substrate;
forming an insulating layer on the electrode composite material layer; and
discharging 5 to 40 pL of droplets of a liquid composition containing inorganic particles having an insulating property and a solvent, from a liquid discharge head when forming the insulating layer,
wherein the liquid discharge head has a discharge resolution of 300 dpi or more in the a nozzle direction and has a discharge resolution of 600 dpi or more in a moving direction.

7. The method of manufacturing an electrode according to claim 6, wherein the discharge resolution of the liquid discharge head in the moving direction is controlled by adjusting the number of times a voltage pattern is applied when the droplets of the liquid composition are discharged from the liquid discharge head.

8. An electrochemical device having an electrode according to claim 1.
